(19) United States
(12) Patent Application Publication
(10) Pub. No.: US 2026/0004249 A1
(43) Pub. Date: Jan. 1, 2026

(54) USING AN ARTIFICIAL INTELLIGENCE MODEL TO IDENTIFY A PRODUCER AND CONSUMER MATCH

(71) Applicant: Sequoia Benefits and Insurance Services, LLC, San Mateo, CA (US)

(72) Inventors: Dustin Steven Schodt, Gilbert, AZ (US); Joseph David Hubbs, Brooklyn, NY (US); Ruth Buel, Sunnyvale, CA (US); Dennis Dale Warner, JR., Wesley Chapel, FL (US); Sean Beckstead, San Mateo, CA (US); Martina Lendova Huamonte, Aldie, VA (US); Fran Glaser, Matawan, NJ (US); Eric Stephen Sankner, Downingtown, PA (US); Maya Louise Estrada, Richmond, CA (US); David Aaron Finklestein, Phoenix, AZ (US); Laura Katharina Bergner, San Francisco, CA (US); Marissa Kelly Lyons, JR., Walnut Creek, CA (US); Jacqueline Gonzalez, Stockton, CA (US)

(21) Appl. No.: 18/757,379

(22) Filed: Jun. 27, 2024

(51) Int. Cl. G06Q 10/1057; G06Q 30/0204

(52) U.S. Cl. CPC G06Q 10/1057; G06Q 30/0205

(57) ABSTRACT

Methods for training and using an artificial intelligence (AI) model to identify a producer and consumer match. The method to train the AI model includes generating training data and providing the training data to train the AI model on (i) a set of training inputs, and (ii) a set of target outputs. A first training input includes information identifying consumer data for a consumer associated with a software-as-a-service (SaaS) management platform. A second training input includes information identifying producer data for a producer that provides, via the SaaS management platform, one or more services to one or more consumers associated with the SaaS management platform. A third training input includes external factor data identifying one or more factors external to and that affect the consumer and producer. A first target output identifies whether the producer is a match for the consumer.

### TECHNICAL FIELD

Aspects and embodiments of the disclosure relate to data processing, and more specifically, to using an artificial intelligence (AI) model to identify a producer and consumer match.

### BACKGROUND

Artificial intelligence (AI) models can help address complex problems across various fields. By leveraging sophisticated algorithms and extensive training data, an AI model can decipher intricate data patters, extract crucial insights, and make informed predictions.

### SUMMARY

The following is a simplified summary of the disclosure to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

An embodiment of the disclosure provides a computer-implemented method for training an artificial intelligence (AI) model, the method comprising: generating training data for an artificial intelligence (AI) model, wherein generating the training data comprises: generating a first training input, the first training input comprising information identifying consumer data related to a consumer associated with a software-as-a-service (SaaS) management platform; generating a second training input, the second training input comprising information identifying first producer data related to a first producer that provides, via the SaaS management platform, one or more services to one or more consumers associated with the SaaS management platform; generating a third training input, the third training input comprising external factor data identifying one or more factors external to and that affect the consumer and the first producer; and generating a first target output for the first training input the second training input and the third training input, wherein the first target output identifies whether the first producer is a match for the consumer; and providing the training data to train the AI model on (i) a set of training inputs comprising the first training input, the second training input and the third training input, and (ii) a set of target outputs comprising the first target output.

In some embodiments, the first target output further identifies whether a service provided by the producer is a match for the consumer.

In some embodiments, the consumer data comprises organization data reflecting information that describes the consumer.

In some embodiments, the consumer data comprises demographic data reflecting demographic characteristics of employees of the consumer.

In some embodiments, the consumer data comprises benefits usage data reflecting a historical usage of a service by the consumer and provided by a second producer.

In some embodiments, the consumer data comprises preference data reflecting one or more preferences of the consumer pertaining to a service provided by the first producer.

In some embodiments, the producer data comprises benefits data reflecting information pertaining to a service provided by the first producer.

In some embodiments, the producer data comprises trend data reflecting information pertaining to cost trends for a service provided by the first producer.

In some embodiments, the producer data comprises relationship data reflecting information pertaining to a relationship between the first producer and the SaaS management platform.

In some embodiments, the external factor data comprises one or more of producer sector data related to a sector of the first producer, economic data related to one or more economic indicators, or world event data related to one or more events external to the first producer and the consumer.

An embodiment of the disclosure provides a computer-implemented method for using a trained AI model the method comprising: providing a trained AI model a first input, the first input comprising information identifying consumer data related to a consumer associated with a software-as-a-service (SaaS) management platform; providing to the trained AI model a second input, the second input comprising information identifying producer data related to a first producer that provides, via the SaaS management platform, a service to one or more consumers associated with the SaaS management platform; providing to the trained AI model a third input, the third input comprising external factor data identifying one or more factors external to and that affect the consumer and the first producer; and obtaining, from the trained AI model, one or more outputs identifying (i) the first producer, and (ii) a level of confidence that the first producer is a match for the consumer.

In some embodiments, method further comprises providing a notification identifying the first producer and indicating that the first producer is the match for the consumer.

In some embodiments, the method further comprises determining whether the level of confidence that the first producer is the match for the consumer satisfies a threshold level of confidence, wherein providing the notification identifying the first producer and indicates that the first producer is the match for the consumer is is responsive to determining that the level of confidence satisfies the threshold level of confidence.

In some embodiments, the method further comprises providing to the trained AI model a fourth input, the fourth input comprising information identifying producer data related to a second producer that provides, via the SaaS management platform, the service to one or more consumers associated with the SaaS management platform; and wherein the one or more outputs identifying (iii) the second producer, and (iv) a level of confidence that the second producer is a match for the consumer.

In some embodiments, the one or more outputs further identify (v) the service of the producer, and (vi) a level of confidence that the service of the first producer is a match for the consumer.

In some embodiments, the consumer data comprises organization data reflecting information that describes the consumer.

In some embodiments, the consumer data comprises demographic data reflecting demographic characteristics of employees of the consumer.

In some embodiments, the consumer data comprises benefits usage data reflecting a historical usage of the service by the consumer and provided by a third producer.

In some embodiments, the consumer data comprises preference data reflecting one or more preferences of the consumer pertaining to the service provided by the first producer.

In some embodiments, the producer data comprises benefits data reflecting information pertaining to the service provided by the first producer.

In some embodiments, the producer data comprises trend data reflecting information pertaining to cost trends for the service provided by the first producer.

In some embodiments, the producer data comprises relationship data reflecting information pertaining to a relationship between the first producer and the SaaS management platform.

In some embodiments, the external factor data comprises one or more of producer sector data related to a sector of the first producer, economic data related to one or more economic indicators, or world event data related to one or more events external to the first producer and the consumer.

A further embodiment(s) of the disclosure provides a system comprising: a memory; and a processing device, coupled to the memory, the processing device to perform a method according to any aspect or embodiment described herein. A further embodiment(s) of the disclosure provides a computer-readable medium comprising instructions that, responsive to execution by a processing device, cause the processing device to perform operations comprising a method according to any aspect or embodiment described herein.

### BRIEF DESCRIPTION OF THE DRAWINGS

Aspects and embodiments of the disclosure will be understood more fully from the detailed description given below and from the accompanying drawings of various aspects and embodiments of the disclosure, which, however, should not be taken to limit the disclosure to the specific aspects or embodiments, but are for explanation and understanding.

FIG. 1 illustrates an example system, in accordance with aspects of the disclosure.

FIG. 2 is an example training set generator to create training data for an AI model using information pertaining to consumer data, producer data, and external factor data, in accordance with aspects of the disclosure.

FIG. 3 illustrates a flow diagram of an example method for training an AI model to identify a producer-consumer match, in accordance with aspects of the disclosure.

FIG. 4 is an example system flow for using a trained AI model to identify a producer-consumer match, in accordance with aspects of the disclosure.

FIG. 5 illustrates a flow diagram of an example method for using a trained AI model to identify a producer-consumer match, in accordance with aspects of the disclosure.

FIG. 6 is a block diagram illustrating an exemplary computer system. in accordance with aspects of the disclosure.

### DETAILED DESCRIPTION

Embodiments described herein are related to methods and systems for using an artificial intelligence (AI) model to identify a producer and consumer match.

A consumer can include an entity that consumes products and/or services. Producers can provide products and/or services for consumption. An agent can function as an intermediary to facilitate the transfer and use of products and/or services between a producer(s) and consumer(s).

For example, a producer can include a carrier (e.g., insurance carrier) that provides benefit packages or plans to an organization (e.g., a consumer) and the personnel thereof. A consumer can include an organization having personnel that use the products and/or services offered by the carrier. A platform, such as a software-as-a-service (SaaS) management platform can function as an agent that offers first-party services (e.g., services developed by the SaaS management platform) and third-party services to the consumers. For instance, the SaaS management platform can facilitate requests to carriers on behalf of consumers for benefit packages and implement an interface (e.g., human resource software) that allows consumers and the personnel thereof to manage subscribed benefit packages.

An agent can submit requests on behalf of a consumer to numerous producers for products and/or services (and the terms thereof). Various factors can limit the number of producers to which a request can be submitted by the agent on behalf of the consumer, such that requests cannot be submitted to all producers. For example, the various factors can include one or more of a limited resources of the agent to obtain, process, or generate producer and/or consumer data, the amount of time to generate a request, the amount of time to receive a response from a producer to a sent request, the quantity and/or type of data to be included in the request, or the like. Once the producers respond to the requests, the agent can determine a subset of the producers that responded that are a match for the consumer. The agent can provide the subset of the producers (and identify the particular products and/or services) to the consumer as a selection of matched producers. Once a producer is selected by the consumer, the agent can implement first-party SaaS services that allow the consumer to manage the services provided by the producer. For example, the agent can determine one or more producers from multiple producers from which to request proposals for products and/or services that are to be provided to a consumer. The producers can respond with benefit information including information about various benefits packages or plans and the terms thereof (e.g., products and//or services for the consumer). The agent can assess the responses, identify a subset of producers (e.g., subset of the one or more producers), and provide the subset of producers and the corresponding benefit information to the consumer for selection. The aforementioned process can be complicated by the numerous data points that are used to select the initial one or more producers from which the agent is to request proposals. The process can be inconsistent and sub-optimal where, for example, consumers with the same or similar profile are matched with different and at times unsuitable producers, at least in part because the agent inconsistently or erroneously determines the initial one or more producers from which to request proposals.

For example, consumers can request information about benefits packages (e.g., products and/or services of the producer), including costs to the consumer and features of the benefits packages. Often many features of the benefits package and costs to the consumer for the benefits package can be specific to the consumer. For instance, the insurance carrier can use information regarding consumer-desired features of the benefits package in combination with information about the consumer to determine the cost to the consumer (e.g., to be paid to the producer) to provide the benefits package to the consumer. Additionally, due to financial, regulatory, or other considerations, some insurance carriers may prefer to provide benefits packages to consumers that meet certain criteria, including for example one or more of a geographic location, a certain headcount size of a consumer, a certain revenue size of a consumer, consumers with employees that have certain demographics, or the like. In another instance, an insurance carrier may prefer to provide benefits packages to consumers with employees of certain demographics (e.g., younger employees). If the demographics of a particular consumer do not match the preferred demographics, the insurance carrier may substantially increase the costs to the consumer. With such complexity, determining which producer(s), such as insurance carriers have a high likelihood of providing benefits packages that are suitable for the consumer and hence, to which producers requests should be sent can be challenging.

Aspects of the present disclosure address the above-mentioned and other challenges by using one or more of consumer data, producer data, or external factor data and an AI model to identify one or more producers that are a match for a consumer. Producer(s) that are a match for the consumer can include producers have a high likelihood of providing products and/or services (e.g., benefits packages) that are suitable for the consumer. In some embodiments, the AI model can identify producers to which requests for services can be sent by the SaaS management platform on behalf of the consumer. In some embodiments, one or more of consumer data, producer data and external factor data (or sub-categories of such data) can be provided as input to the AI model, which can provide, as an output, an indication of one or more producers that are a match for the consumer. In some embodiments, additional outputs can be generated by the AI model, including an indication of a particular product and/or service (e.g., benefit package) of a particular producer (e.g., a producer identified in outputs from the AI model, as described above).

As noted, a technical problem addressed by some embodiments of the disclosure is identifying and/or generating a producer match for a consumer.

A technical solution to the above identified technical problem can include using an AI model and/or other algorithms described herein to identify a producer identifier for a consumer using one or more of consumer data, producer data, or external factor data. Another technical solution is training an AI model to with inputs including one or more of consumer data, producer data, or external factor data that are paired with outputs, and modifying weights of the AI model based on the training.

As noted, another technical problem addressed by some embodiments of the disclosure is identifying and/or generating a product and/or service match for a consumer without having full information pertaining to the producer (e.g., producer criteria in providing services to consumers).

A technical solution to the above identified technical problem can include using the AI model and/or other algorithms to further identify a product and/or service match for a consumer from the identified producer, using one or more of the consumer data, the producer data, or the external factor data. The technical solution allows a computer system to generate accurate estimates of matches between producers (and respective services) and consumers. Such accurate estimates were not possible in previous computer systems at least in part because the lack of access to full information pertain to producers. Further the technical solution can provide automation using for example, a set of rules (e.g., ranking model and/or weights based on an output of one or more AI models) to determining matches between producers and consumers with consistency and/or accuracy that was not previously available (e.g., to solve the problem of matching producers with consumers).

The products and/or services available from an insurance carrier can be referred to herein as “benefits packages.” Benefits packages can include products and/or services for employees associated with the consumer, including for example one or more of (i) health insurance coverage, (ii) vision insurance coverage, (iii) dental insurance coverage, (iv) disability and/or life insurance coverage, (v) retirement account options, (vi) employee assistance programs (EAPs), (vii) transportation arrangements, (viii) employee discounts, or the like. Benefits packages can also include products and/or services for the consumer, including for example one or more of (i) property insurance coverage, (ii) workplace insurance coverage, (iii) cyber event insurance coverage, (iv) other risk-based insurance coverage, or the like.

An “organization” can refer to an entity, such as a legal entity that includes multiple people (e.g., organization personnel) that has a particular purpose. Examples of organizations can include government agencies, non-profits, corporations (e.g., authorized by law to act as a single entity or legal entity), and partnerships.

A “consumer” or “client organization” (also referred to as “client” herein) can refer to an entity that accesses services from a platform, such as the SaaS management platform provided by a first-party organization (e.g., an agent). In some embodiments, the entity can include an organization having personnel (also referred to as “employees” herein) that access products and/or services via the SaaS management platform. For example, the employees of a consumer organization can access services of the SaaS management platform using respective consumer accounts. In some embodiments, the consumer can subscribe to first-party services offered by the SaaS management platform. In some embodiments, the consumer accesses first-party products and/or services provided by the SaaS management platform. In some embodiments, the consumer can subscribe to third-party products and/or services provided by a third-party, such as a producer. In some embodiments, the consumer accesses or consumes products and/or services of a producer (e.g., third-party product and/or services) via the SaaS management platform where the products and/or services are facilitated by the SaaS management platform. For example, the consumer can include one or more employees (typically many employees) that carry out the goals and functions of the consumer organization and receive benefits, such as healthcare or retirement plans. The SaaS management platform identify one or more producers that offer benefit packages that are suitable for the consumer. The consumer can subscribe to a particular benefit package from a particular producer, and the SaaS management platform can provide an interface that allows the consumer and the employees thereof to manage one or more features of the particular benefit package.

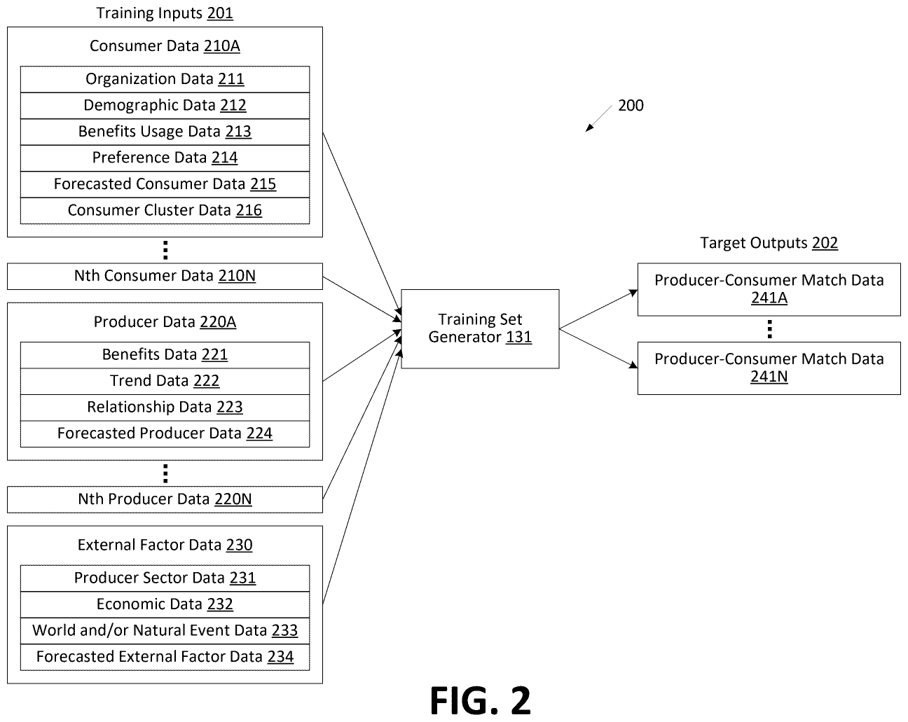

“Consumer data” generally describes information associated with, derived from, or describing a consumer. For example, consumer data can include one or more of information that describes the consumer or the employees thereof (e.g., organization data, or demographic data), information derived from consumer activities (e.g., benefits usage data), or information provided by the consumer to the SaaS management platform (e.g., preference data). Additional details regarding consumer data are described below with reference to FIG. 2.

A “producer” can provide products and/or services (e.g., benefit packages) to an individual or another organization, such as the consumer. In some embodiments, the producer is an organization, such as a carrier (e.g., insurance carrier). In some embodiments, the products and/or services provided by the producer can be facilitated and/or managed by the SaaS management platform. For example, the producer (e.g., insurance carrier) can provide employee benefit packages, such as one or more of employee insurance, retirement plans, property insurance, risk insurance, or the like to a consumer. The SaaS management platform can facilitate a request from the consumer to the producer for products and/or services. In some embodiments, the SaaS management platform can facilitate a response from the producer to the consumer corresponding to the consumer request. The SaaS management platform can further provide an interface (e.g., graphical user interface (GUI)) that allows the consumer and the employees thereof to visualize and manage features of employee benefit packages.

“Producer data” can refer information associated with, derived from, or describing a producer. For example, producer data can include information about the products and/or services provided by the producer. In some embodiments, the producer data can include one or more of information that describes types of products and/or services provided by the producer (e.g., benefits data), information that describes cost trends (e.g., trend data), information about the producer derived by the first-party organization (e.g., relationship data), or the like. Additional details regarding producer data are described below with reference to FIG. 2.

A “sector” can refer the industry or segment (e.g., segment of the economy) that an organization targets with products and/or services. The sector can include organizations that provide similar products and/or services. For example, a producer (e.g., insurance carrier) can provide similar products and/or services as other producers of a producer sector (e.g., industry). In another example, a consumer can provide similar products and/or services as other consumers in a consumer sector.

“External factor data” can includes that information reflects one or more factors or variables, such as events, influences or conditions that can impact one or more of a consumer or producer. In some embodiments, the events, influences, or conditions can be external events, external influences, or external conditions. The events, influences or conditions may affect one or more of the consumer or the producer, but are not controlled by either the consumer or the producer. External factor data can include one or more of consumer sector data, producer sector data, economic data, world and/or natural event data, or the like. Additional details regarding producer data are described below with reference to FIG. 2.

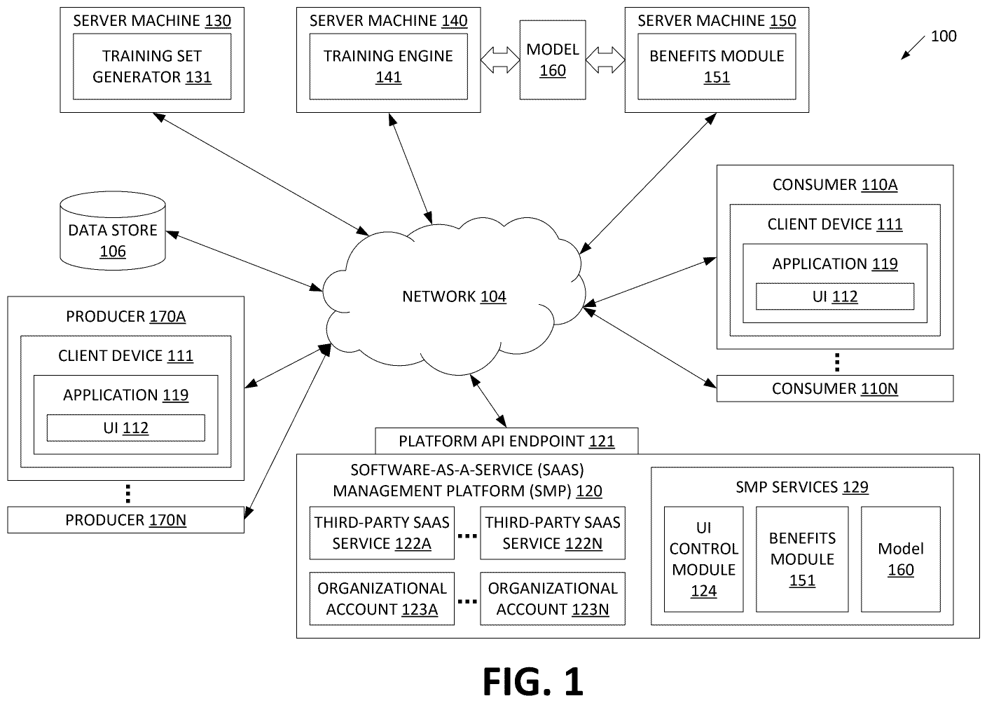

FIG. 1 illustrates an example of a system 100, in accordance with aspects of the disclosure. The system 100 includes a SaaS management platform 120, one or more server machines 130-150, a data store 106, and the consumer 110A through the consumer 110N connected to network 104. In some embodiments, the system 100 can include one or more other platforms (e.g., “third-party platforms”).

In some embodiments, network 104 can include a public network (e.g., the Internet), a private network (e.g., a local area network (LAN) or wide area network (WAN)), a wired network (e.g., Ethernet network), a wireless network (e.g., an 802.11 network or a wireless fidelity (Wi-Fi) network), a cellular network (e.g., a Long Term Evolution (LTE) network), routers, hubs, switches, server computers, and/or a combination thereof.

Data store 106 can be a persistent storage that is capable of storing data such as consumer data, producer data, external factor data, AI model data, etc. Data store 106 can be hosted by one or more storage devices, such as main memory, magnetic or optical storage based disks, tapes or hard drives, network-attached storage (NAS), storage area network (SAN), and so forth. In some embodiments, data store 106 can be a network-attached file server, while in other embodiments the data store 106 can be another type of persistent storage such as an object-oriented database, a relational database, and so forth, that can be hosted by SaaS management platform 120, or one or more different machines coupled to the server hosting the SaaS management platform 120 via the network 104. In some embodiments, data store 106 can be capable of storing one or more data items, as well as data structures to tag, organize, and index the data items. A data item can include various types of data including structured data, unstructured data, vectorized data, etc., or types of digital files, including text data, audio data, image data, video data, multimedia, interactive media, data objects, and/or any suitable type of digital resource, among other types of data. An example of a data item can include a file, database record, database entry, programming code or document, among others. In some embodiments, data store 106 can include historical information (e.g., historical data items) related to one or more of consumer data, producer data, external factor data, or the like.

One or more of a consumer 110A (e.g., also referred to herein as a “client organization”) or a consumer 110N (also referred to herein as “consumers 110A-110N”) can refer to an organization that uses the services provided by the SaaS management platform 120. The consumers 110A-110N can each include one or more client devices 111. The client device(s) (e.g., client device 111) may each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some embodiments, client devices 111 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some embodiments, client device(s) may also be referred to as a “client device” herein. Although a single client device 111 is shown for purposes of illustration rather than limitation, one or more client devices can be implemented in some embodiments. Client device 111 will be referred to as client device 111 or client devices 111 interchangeably herein.

In some embodiments, the SaaS management platform 120 can group the consumers 110A-110N into one or more “client clusters” (also referred to herein as “consumer clusters”) based on a similarity between one or more characteristics of the consumers 110A-110N. In some embodiments, the model 160, or another model (e.g., another AI model) can be trained to cluster the consumers 110A-110N into one or more consumer clusters. In some embodiments, clustering algorithms can be used to cluster the consumers 110A-110N, including for example one or more of K-means clustering, hierarchical clustering, density-based spatial clustering of applications with noise (DBSCAN), or Gaussian mixture clustering. In some embodiments, clustering the consumers 110A-110N into one or more clusters can generate consumer cluster data for each organization. Additional details regarding consumer cluster data are described below with reference to FIG. 2.

In some embodiments, characteristics of the consumers 110A-110N used for clustering can include one or more of organization data, demographic data, benefits usage data, or preference data. Additional details regarding these characteristics are described below with reference to FIG. 2.

In some embodiments, a client device, such as client device 111, can implement or include one or more applications, such as application 119 executed at client device 111. In some embodiments, application 119 can be used to communicate (e.g., send and receive information) with SaaS management platform 120. In some embodiments, application 119 can implement user interfaces (UIs) (e.g., graphical user interfaces (GUIs)), such as a user interface (UI) (e.g., UI 112) that may be webpages rendered by a web browser and displayed on the client device 111 in a web browser window. In another embodiment, the UIs 112 of client application, such as application 119 may be included in a stand-alone application downloaded to the client device 111 and natively running on the client device 111 (also referred to as a “native application” or “native client application” herein). In some embodiments, the benefits module 151 can be implemented as part of application 119. In other embodiments, the benefits module 151 can be separate from application 119 and application 119 can interface with benefits module 151.

In some embodiments, one or more client devices 111 can be connected to the system 100. In some embodiments, client devices, under direction of the SaaS management platform 120 when connected, can present (e.g., display) a UI 112 to a user of a respective client device through application 119. The client devices 111 may also collect input from users through input features.

In some embodiments, a UI 112 may include various visual elements (e.g., UI elements) and regions, and can be a mechanism by which the user engages with the SaaS management platform 120, and the system 100 at large. In some embodiments, the UI 112 of a client device 111 can include multiple visual elements and regions that enable presentation of information, for decision-making, content delivery, etc. at a client device 111. In some embodiments, the UI 112 may sometimes be referred to as a graphical user interface (GUI)).

In some embodiments, the UI 112 and/or client device 111 can include input features to intake information from a client device 111. In one or more examples, a user of client device 111 can provide input data (e.g., a user query, control commands, etc.) into an input feature of the UI 112 or client device 111, for transmission to the SaaS management platform 120, and the system 100 at large. Input features of UI 112 and/or client device 111 can include space, regions, or elements of the UI 112 that accept user inputs. For example, input features may include visual elements (e.g., GUI elements) such as buttons, text-entry spaces, selection lists, drop-down lists, etc. For example, in some embodiments, input features may include a chat box which a user of client device 111 can use to input textual data (e.g., a user query). The application 119 via client device 111 can then transmit that textual data to SaaS management platform 120, and the system 100 at large, for further processing. In other examples, input features can include a selection list, in which a user of client device 111 can input selection data e.g., by selecting, or clicking. The application 119 via client device 111 can then transmit that selection data to SaaS management platform 120, and the system 100 at large, for further processing.

One or more of a producer 170A (e.g., also referred to herein as a “carrier” or “carrier organization”) or an nth producer 170N (also referred to herein as “producers 170A-170N”) can refer to an organization that provides one or more products and/or services (e.g., benefits packages) to consumers 110A-110N through the SaaS management platform 120. As illustrated, the producers 170A-170N can include one or more client devices 111, which can include one or more of the application 119 or the UI 112 as described above with reference to consumers 110A-110N. In some embodiments, the one or more producers 170A-170N can provide one or more third-party SaaS services 122A-122N to one or more consumers 110A-110N through the SaaS management platform 120.

In some embodiments, a client device 111 can access the SaaS management platform 120 through network 104 using one or more application programming interface (API) calls via platform API endpoint 121. In some embodiments, SaaS management platform 120 can include multiple platform API endpoints 121 that can expose services, functionality, or information of the SaaS management platform 120 to one or more client devices 111. In some embodiments, a platform API endpoint 121 can be one end of a communication channel, where the other end can be another system, such as a client device 111 associated with a user account. In some embodiments, the platform API endpoint 121 can include or be accessed using a resource locator, such a universal resource identifier (URI), universal resource locator (URL), of a server or service. The platform API endpoint 121 can receive requests from other systems, and in some cases, return a response with information responsive to the request. In some embodiments, HTTP (Hypertext Transfer Protocol), HTTPS (Hypertext Transfer Protocol Secure) methods (e.g., API calls) can be used to communicate to and from the platform API endpoint 121.

In some embodiments, the platform API endpoint 121 can function as a computer interface through which access requests are received and/or created. In some embodiments, the platform API endpoint 121 can include a platform API whereby external entities or systems can request access to services and/or information provided by the SaaS management platform 120. The platform API can be used to programmatically obtain services and/or information associated with a request for services and/or information.

In some embodiments, the API of the platform API endpoint 121 can be any suitable type of API such as a REST (Representational State Transfer) API, a GraphQL API, a SOAP (Simple Object Access Protocol) API, and/or any suitable type of API. In some embodiments, the SaaS management platform 120 can expose through the API, a set of API resources which when addressed can be used for requesting different actions, inspecting state or data, and/or otherwise interacting with the SaaS management platform 120. In some embodiments, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the SaaS management platform 120 can observe the principals of a RESTful design or the protocol of the type of API. RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

It can be appreciated that in some embodiments, any element, such as server machine 130, server machine 140, server machine 150, and/or data store 106 may include a corresponding API endpoint for communicating with APIs.

In some embodiments, the SaaS management platform 120 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to data or services. Such computing devices can be positioned in a single location or can be distributed among many different geographical locations. For example, SaaS management platform 120 can include a plurality of computing devices that together may comprise a hosted computing resource, a grid computing resource, or any other distributed computing arrangement. In some embodiments, SaaS management platform 120 can correspond to an elastic computing resource where the allotted capacity of processing, network, storage, or other computing-related resources may vary over time.

In some embodiments, the SaaS management platform 120 can include one or more third-party SaaS services 122A through third party SaaS services 122N (also referred to herein as “third-party SaaS services 122A-122N”). In some embodiments, the SaaS management platform 120 can include one or more first-party services, illustratively shown as SaaS management platform (SMP) services 129 (also referred to herein as SMP services 129). When a client device 111 accesses the SaaS management platform 120, the SaaS management platform 120 can provide the client device 111 with access to one or more services (e.g., one or more third-party SaaS services 122A-122N). In some embodiments, the client device 111 can access a data item using one or more of the SaaS management platform services 129 or one or more of the third-party SaaS services 122A-122N. The client device 111 receives a data item from the SaaS management platform 120 in response to a request for the data item. In some embodiments, the SaaS management platform 120 can function as a “black box” with respect to the client device 111. That is, regardless of the original source of the data item (e.g., whether from the SaaS management platform services 129, or from one or more third-party SaaS services 122A-122N) the client device 111 can receive the data item as if the data item originated from the SaaS management platform 120.

In some embodiments, SaaS management platform 120 can provide an organizational accounts 123A through an organizational account 123N that are assigned to a particular organization, such as a consumer 110A or a consumer 110N, respectively. For example, Corporation A can be assigned organizational account 123A and corporation N can be assigned organizational account 123N. In some embodiments, SaaS management platform 120 can provide an organizational account 123A with one or more user accounts. For example, organizational account 123A can be a root account and user accounts (e.g., for employees of an organization) can be under the root account in a hierarchical structure. In some embodiments, a consumer 110A (or SaaS management platform 120) can assign user accounts to respective users within the organization. User accounts can be used to access the SaaS management platform 120 via client devices 111A-111N. A “user” can be an individual of the organization associated with a respective user account. In some embodiments, aspects of the disclosure encompass a “user” being an entity controlled by a group of organization personnel and/or an automated source. For example, a group of organization personnel federated as one or more departments in an organization can be considered a “user.” Each user account can be assigned authorization credentials to access the SaaS management platform 120 (e.g., a username and password) and further use authentication credentials (e.g., an access token, etc.) to access specific services provided thereby. In some embodiments, user accounts can include enhanced privileges (e.g., administrator accounts, information technology (IT) specialist accounts, etc.).

In some embodiments, the SaaS management platform services 129 can provide one or more services to the consumer 110A (including employees of the consumer 110A). In some embodiments, SaaS management platform services 129 can also include a benefits module 151. The benefits module 151 can receive information from the SaaS management platform 120 (e.g., consumer data, producer data, external factor data, etc.) and provide the received information as input to the model 160. The benefits module 151 can obtain output generated by the model 160 based on the information provided as an input.

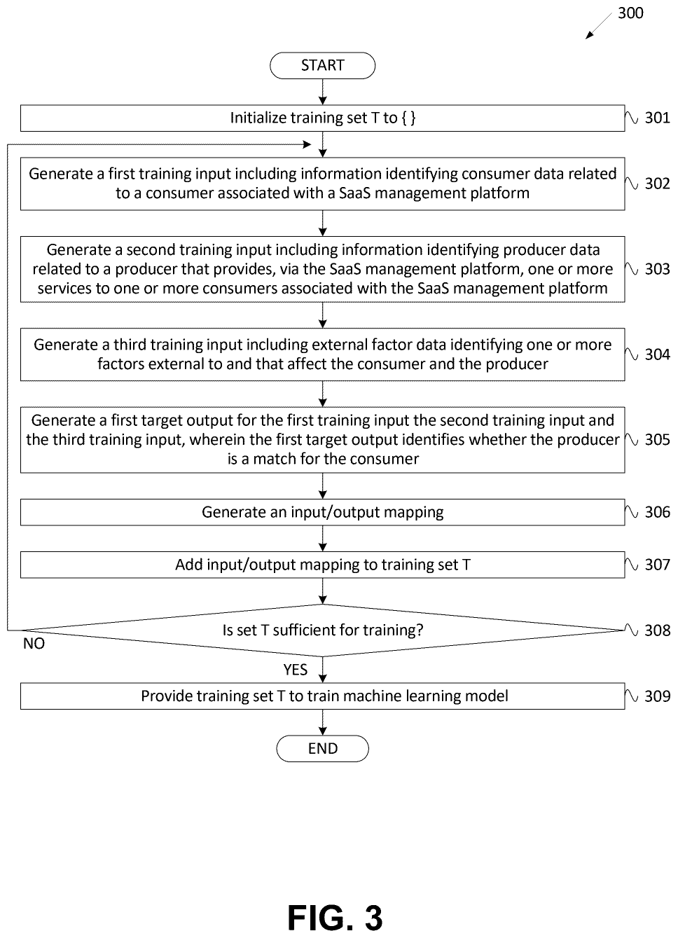

In some embodiments, SaaS management platform 120 can implement the benefits module 151. In some embodiments, the benefits module 151 can implement one or more features and/or operations as described herein. In some embodiments, the benefits module 151 can include or access the model 160. In some embodiments, the SaaS management platform 120 can receive one or more of consumer data, producer data, or external factor data. The SaaS management platform 120 can provide the consumer data, the producer data, and/or the external factor data to the benefits module 151. In some embodiments, the benefits module 151 can use the consumer data, the producer data, and/or the external factor data as input to a trained AI model, such as model 160. Model 160 can generate one or more outputs. As described above, in some embodiments, the benefits module 151 can obtain cluster data and use the cluster data along with one or more of the consumer data, the producer data and/or the external factor data as input to the trained AI model. In some embodiments, the benefits module 151 can perform input preprocessing on data received as input for the model 160. Additional details regarding training the AI model are described below with reference to FIG. 2 and FIG. 3.

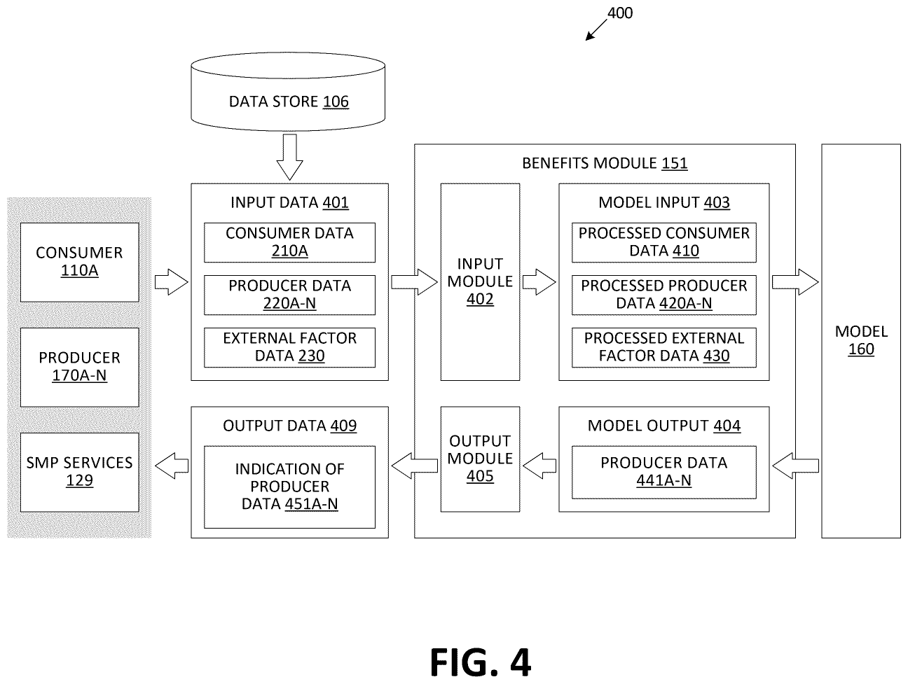

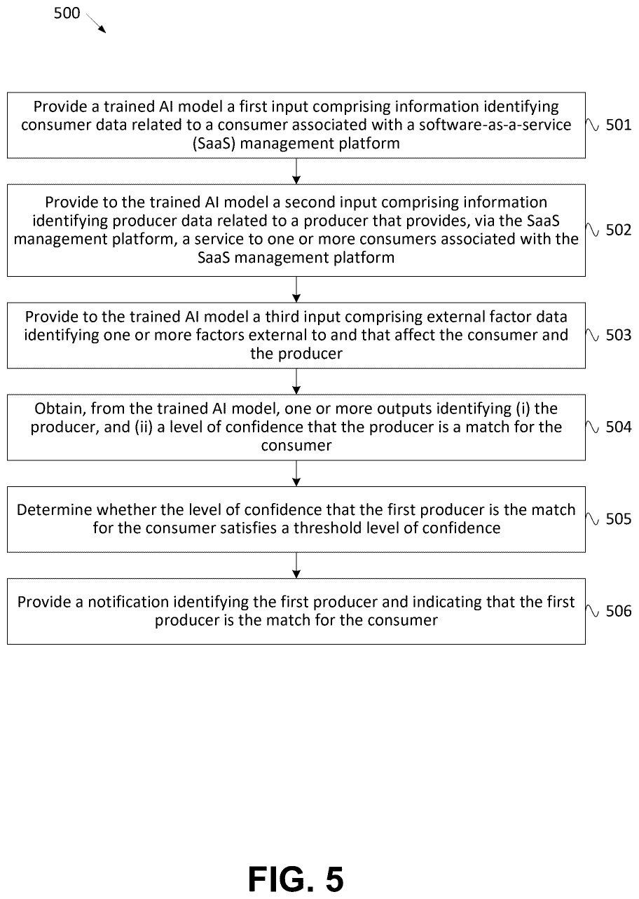

The benefits module 151 can obtain one or more outputs from the AI model (e.g., model 160). In some embodiments, the benefits module 151 can provide the one or more outputs to one or more of the SaaS management platform 120, a client device 111 of a consumer 110A, or a client device 111 of a producer 170A. In some embodiments, the benefits module 151 can perform output postprocessing on data received as output from the model 160. Additional details regarding using the AI model (e.g., model 160) are described below with reference to FIG. 4 and FIG. 5.

In some embodiments, SaaS management platform 120 and in particular, the UI control module 124 may perform user-display functionalities of the system such as generating, modifying, and monitoring the client-side UIs (e.g., graphical user interfaces (GUI)) and associated components that are presented to users of the SaaS management platform 120 through UI 112 client devices 111. For example, the benefits module 151 via UI control module 124 can generate the UIs (e.g., UI 112 of client device 111) that users interact with while engaging with the SaaS management platform 120.

In some embodiments, an artificial intelligence (AI) model (e.g., also referred to as an “machine learning model” herein) can include a discriminative AI model (also referred to as “discriminative machine learning model” herein), a generative AI model (also referred to as “generative machine learning model” herein), and/or other AI model.

In some embodiments, a discriminative AI model can model a conditional probability of an output for given input(s). A discriminative AI model can learn the boundaries between different classes of data to make predictions on new data. In some embodiments, a discriminative AI model can include a classification model that is designed for classification tasks, such as learning decision boundaries between different classes of data and classifying input data into a particular classification. Examples of discriminative AI models include, but are not limited to, support vector machines (SVM) and neural networks.

In some embodiments, a generative AI model learns how the input training data is generated and can generate new data (e.g., original data). A generative AI model can model the probability distribution (e.g., joint probability distribution) of a dataset and generate new samples that often resemble the training data. Generative AI models can be used for tasks involving image generation, text generation and/or data synthesis. Generative AI models include, but are not limited to, gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and so forth.

Training of and inference using discriminative AI models (e.g., machine learning models) is described herein. Server machine 130 includes a training set generator 131 that is capable of generating training data (e.g., a set of training inputs and a set of target outputs) to train a model 160 (e.g., a discriminative AI model). In some embodiments, training set generator 131 can generate the training data based on various data (e.g., stored at data store 106 or another data store connected to the system 100 via the network 104). The data store 106 can store metadata associated with the training data.

Server machine 140 includes a training engine 141 that is capable of training a model 160 using the training data from training set generator 131. The model 160 (also referred to “machine learning model” or “artificial intelligence (AI) model” herein) may refer to the model artifact that is created by the training engine 141 using the training data that includes training inputs (e.g., features) and corresponding target outputs (correct answers for respective training inputs) (e.g., labels). The training engine 141 may find patterns in the training data that map the training input to the target output (the answer to be predicted) and provide the model 160 that captures these patterns. The model 160 may be composed of, e.g., a single level of linear or non-linear operations (e.g., a support vector machine (SVM), or may be a deep network, i.e., an AI model that is composed of multiple levels of non-linear operations). An example of a deep network is a neural network with one or more hidden layers, and such AI model may be trained by, for example, adjusting weights of a neural network in accordance with a backpropagation learning algorithm or the like. Model 160 can use one or more of a support vector machine (SVM), Radial Basis Function (RBF), clustering, supervised AI, semi-supervised AI, unsupervised AI, k-nearest neighbor algorithm (k-NN), linear regression, random forest, neural network (e.g., artificial neural network), a boosted decision forest, etc. For convenience rather than limitation, the remainder of this disclosure describing discriminative AI model will refer to the implementation as a neural network, even though some implementations might employ other type of learning machine instead of, or in addition to, a neural network.

In some embodiments, such as with a supervised AI model, the one or more training inputs of the set of the training inputs are paired with respective one or more training outputs of the set of training outputs. The training input-output pair(s) can be used as input to the AI model to help train the AI model to determine, for example, patterns in the data. The model parameters (e.g., values thereof) can be adjusted based on the training.

In some embodiments, training data, such as training input and/or training output, and/or input data to a trained AI model (collectively referred to as “AI model data” herein) can be preprocessed before providing the aforementioned data to the (trained or untrained) AI model (e.g., discriminative AI model and/or generative AI model) for execution. Preprocessing as applied to AI models (e.g., discriminative AI model and/or generative AI model) can refer to the preparation and/or transformation of AI model data.

In some embodiments, preprocessing can include data scaling. Data scaling can include a process of transforming numerical features in raw AI model data such that the preprocessed AI model data has a similar scale or range. For example, Min-Max scaling (Normalization) and/or Z-score normalization (Standardization) can be used to scale the raw AI model. For instance, if the raw AI model data includes feature representing temperatures in Fahrenheit, the raw AI model data can be scaled to a range of [0, 1] using Min-Max scaling.

In some embodiments, preprocessing can include data encoding. Encoding data can include a process of converting categorical or text data into a numerical format on which a AI model can efficiently execute. Categorical data (e.g., qualitative data) can refer to a type of data that represents categories and can be used to group items or observations into distinct, non-numeric classes or levels. Categorical data can describe qualities or characteristics that can be divided into distinct categories, but often does not have a natural numerical meaning. For example, colors such as red, green, and blue can be considered categorical data (e.g., nominal categorical data with no inherent ranking). In another example, “small,” “medium,” and “large” can be considered categorical data (ordinal categorical data with an inherent ranking or order). An example of encoding can include encoding a size feature with categories [“small,” “medium,” “large”] by assigning 0 to “small,” 1 to “medium,” and 2 to “large.”

In some embodiments, preprocessing can include data embedding. Data embedding can include an operation of representing original data in a different space, often of reduced dimensionality (e.g., dimensionality reduction), while preserving relevant information and patterns of the original data (e.g., lower-dimensional representation of higher-dimensional data). The data embedding operation can transform the original data so that the embedding data retains relevant characteristics of the original data and is more amenable for analysis and processing by AI models. In some embodiments embedding data can represent original data (e.g., word, phrase, document, or entity) as a vector in vector space, such as continuous vector space. Each element (e.g., dimension) of the vector can correspond to a feature or property of the original data (e.g., object). In some embodiments, the size of the embedding vector (e.g., embedding dimension) can be adjusted during model training. In some embodiments, the embedding dimension can be fixed to help facilitate analysis and processing of data by AI models.

In some embodiments, the training set is obtained from server machine 130. Server machine 150 includes a benefits module 151 that provides current data (e.g., customer data, etc.) as input to the trained AI model (e.g., model 160) and runs the trained AI model (e.g., model 160) on the input to obtain one or more outputs.

In some embodiments, confidence data can include or indicate a level of confidence of that a particular output (e.g., output(s)) corresponds to one or more inputs of the AI model (e.g., trained AI model). In one example, the level of confidence is a real number between 0 and 1 inclusive, where 0 indicates no confidence that output(s) corresponds to a particular one or more inputs and 1 indicates absolute confidence that the output(s) corresponds to a particular one or more inputs. In some embodiments, confidence data can be associated with inference using an AI model.

In some embodiments, an AI model, such as model 160, may be (or may correspond to) one or more computer programs executed by processor(s) of server machine 140 and/or server machine 150. In other embodiments, an AI model may be (or may correspond to) one or more computer programs executed across a number or combination of server machines. For example, in some embodiments, AI models may be hosted on the cloud, while in other embodiments, these AI models may be hosted and perform operations using the hardware of a client device 111. In some embodiments, the AI models may be a self-hosted AI model, while in other embodiments, AI models may be external AI models accessed by an API.

In some embodiments, server machines 130 through 150 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to one or more data items of the SaaS management platform 120. The SaaS management platform 120 can also include a website (e.g., a webpage) or application back-end software that can be used to provide users with access to the SaaS management platform 120.

In some embodiments, one or more of server machine 130, server machine 140, model 160, server machine 150 can be part of SaaS management platform 120. In other embodiments, one or more of server machine 130, server machine 140, server machine 150, or model 160 can be separate from SaaS management platform 120 (e.g., provided by a third-party service provider).

Also as noted above, for purpose of illustration, rather than limitation, aspects of the disclosure describe the training of an AI model (e.g., model 160) and use of a trained AI model (e.g., model 160). In other embodiments, a heuristic model or rule-based model can be used as an alternative. It should be noted that in some other embodiments, one or more of the functions of SaaS management platform 120 can be provided by a greater number of machines. In addition, the functionality attributed to a particular component of the SaaS management platform 120 can be performed by different or multiple components operating together. Although embodiments of the disclosure are discussed in terms of beauty products platforms, embodiments can also be generally applied to any type of platform or service.

In situations in which the systems discussed here collect personal information about users, or can make use of personal information, the users of client devices 111 can be provided with an opportunity to control whether or how the SaaS management platform 120 collects user information. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the SaaS management platform 120.

FIG. 2 is an example training set generator to generate training data for an AI model using information pertaining to one or more of consumer data, producer data, and external factor data, in accordance with aspects of the disclosure. System 200 shows a training set generator 131, training inputs 201, and target outputs 202. System 200 can include similar components as the system 100, as described in FIG. 1. Components described with reference to the system 100 of FIG. 1 can be used to describe system 200 of FIG. 2.

In some embodiments, training set generator 131 generates training data that includes one or more training inputs 201, and one or more target outputs 202. The training data can include mapping data that maps the training inputs 201 to the target outputs 202. Training inputs 201 can also be referred to as “features” or “attributes,” herein. In some embodiments, training set generator 131 can provide the training data in a training set, and provide the training set to the training engine 141 (not illustrated) where the training set is used to train the model 160. Generating a training set is further described with reference to FIG. 3.

In some embodiments a target output 202 can be generated for each combination of training inputs 201. For example, and in some embodiments, for the training inputs 201 including consumer data 210A for a first consumer and producer data 220A for a first producer, the training set generator 131 can generate a first set of target outputs 202. In another example, for the training inputs 201 including consumer data for the particular consumer and nth producer data 220N for an nth producer, the training set generator 131 can generate a second set of target outputs 202. In some embodiments, a target output 202 can be generated for multiple combinations of training inputs 201. For example, and in some embodiments, for the training inputs 201 including consumer data 210A for a first consumer, producer data 220A for a first producer, nth producer data 220N for an nth producer, and external factor data 230, the training set generator 131 can generate a first set of target outputs 202 (e.g., producer consumer match data for each of the nth producers).

### Training Inputs

Training inputs 201 can include one or more of consumer data 210A through consumer data 210N (also referred to herein as “consumer data 210A-210N”), producer data 220A through producer data 220N (also referred to herein as “producer data 220A-220N”), or external factor data 230.

As described above, consumer data 210A can include one or more of information that describes the consumer or the employees thereof (e.g., organization data 211, or demographic data 212), information derived from consumer activities (e.g., benefits usage data 213), or information provided by the consumer to the SaaS management platform (e.g., preference data 214). An nth consumer data 210N can be provided as an additional training input. For example, consumer data 210A can be associated with a first consumer, and nth consumer data 210N can be associated with an nth consumer. In some embodiments, consumer data 210A includes one or more of organization data 211, demographic data 212, benefits usage data 213, preference data 214, or the like.

Organization data 211 can include information that describes the consumer. For example, and in some embodiments, organization data 211 can include one or more of location data, employee data, financial data, or consumer sector data.

Location data can include information that identifies geographic positions or physical locations relevant to the operations, activities, assets, or employees of a consumer. In some embodiments, location data includes one or more of (i) a physical, logistical, and/or incorporation location of a consumer's headquarters, (ii) physical locations of consumer facilities or operations, (iii) the residential location of consumer employees (e.g., State A, or State B), (iv) the working location of consumer employees, (v) or similar location-based metrics.

Employee data can include information related to individuals employed by the consumer (e.g., organization personnel). In some embodiments, employee data includes one or more of employee details (e.g., job position, employment status, location, in-office or in-home work status), compensation and benefits, leave and attendance, and so forth. In some embodiments, employee data can be related to an aggregate of some, or all the individuals employed by the consumer. For example, employee data can include headcount or average age of the employees, etc. In another example, employee data can include the number of employees of a consumer that work onsite versus the number of employees of the consumer that work at home. For instance, if a relatively larger number of employees of the consumer work at home, a cost to the consumer for products and/or services from the producer may be relatively lower. In some embodiments, a producer can offer custom benefits package options for consumers with an employee headcount above a certain headcount threshold. For example, a producer can offer non-custom benefits package options to consumers with a headcount less three hundred employees, and custom benefits package options to consumers with a headcount greater than or equal to three hundred employees. In another example, consumers with five hundred or more employees may allow for consideration of stop-loss or self-insurance options.

Financial data can include information that describes financial activities of the consumer. In some embodiments, financial data includes information such as one or more of revenue data, expense data, salary data, asset data, liability data, profitability data, cash flow data, funding data (e.g., venture capitalist (VC) funding round data), other financial funding data, or the like. For example, major funding rounds at a startup (as provided by a VC firm) can indicate that the startup (e.g., the consumer) will prefer to have a “richer” benefits package. As used herein, a “richer” benefits package refers to a benefits package that has more robust features, services, and/or products. In another example, a major funding round can indicate that the consumer will not prioritize cost-savings strategies when selecting a producer to provide products and/or services. In another example, a lower round of funding can indicate that the consumer will prioritize cost-savings strategies when selecting the producer to provide products and/or services. In some embodiments, financial data can include information regarding the amount, and/or type of payment made by a consumer to a current producer for products and/or services. For example, a consumer can be receiving products and/or services from a current producer while simultaneously seeking a new producer from whom to obtain products and/or services.

Consumer sector data can include information related to a sector or industry(ies) served by the consumer. In some embodiments, the consumer sector data can describe the sector serviced by the consumer and activities or events external to the consumer that may affect the consumer, but are not necessarily controlled by the consumer. In some embodiments, consumer sector data includes one or more of statistics, performance data, trends, and/or characteristics of other organizations within the same consumer sector as a particular consumer. For example, consumer sector data can include competitor information. In another example, consumer sector data can identify the consumer sector, e.g., the “VC sector” or the “tech sector.”

Demographic data 212 can include information that describes characteristics (e.g., demographic characteristics) of personnel associated with the consumer (e.g., employees of the consumer). In some embodiments, demographic data 212 includes one or more of age, gender, family status (e.g., marital status, number of dependents, and the like), job title, salary, residential location, or the like. In some embodiments, demographic data can be used to understand the employees of an organization in aggregate without using personally identifiable information of individual employees.

Benefits usage data 213 can include information that describes a consumer's usage of products and/or services provided by a producer. For example, and in some embodiments, benefits usage data 213 can include or identify one or more of (i) the product(s) and/or service(s) provided to the consumer by the producer, (ii) the usage of the product(s) and/or service(s) by the consumer, and (iii) forecasted usage of product(s) and/or service(s) by a consumer in the future (e.g., within a time period). For example, the carrier can provide the consumer with one hundred hours of services (e.g., identified service), but the consumer may only use fifty hours of the service provided by the carrier (e.g., usage rate of 50%). In another example, a producer can provide employees of the consumer with an out-of-pocket maximum of $3,000 for health-related expenses, but the employee of the consumer may actually spend $7,000 on health-related expenses (representing $4,000 of unused health-related expenses). In some embodiments, the benefits usage data 213 can reflect a historical usage of products and/or services provided by one or more of the producer, or another producer.

Preference data 214 can include information that reflects consumer preference(s). In some embodiments, the preference data 214 can be received from the consumer (e.g., via a client device). In some embodiments, the preference data 214 can be derived from, or determined by the SaaS management platform (e.g., SaaS management platform 120). In some embodiments, the preference data 214 can describe expectations of the consumer for products and/or service(s) provided by a producer. Preference data 214 can include one or more of financial expectations, quality expectations, variety expectations, functional expectations, or the like. For example, financial expectations may be an expected cost of the products and/or services provided by a producer. In another example, financial expectations may be an expected cost savings by switching from a current producer to a new producer. In another example, quality expectations may include a threshold quality of the service provided by the producer. In another example, variety expectations may include requirements about the types (e.g., “variations”) of the service(s) provided by the producer. In another example, functional expectations may include functional, or “system” requirements of the services provided by the producer in order for the consumer to effectively integrate the service. In some embodiments, one or more of expectations included in preference data 214 can be satisfied by a particular service provided by a particular provider. In some embodiments, one or more expectations included in preference data 214 may not be satisfied by a particular service provided by a particular provider.

Forecasted consumer data 215 can refer to information that estimates or predicts future outcomes, events, or trends related to a consumer. In some embodiments, forecasted consumer data 215 can be related to a specific time period. For example, the forecasted consumer data 215 can be for one year into the future. In another example, an analysis of consumer data 210A can indicate one or more trends that forecasts some value for the forecasted consumer data 215. In some embodiments, forecasted consumer data 215 can be associated with statistics or probabilities of one or more events happening, or not happening within the specified time period. For example, a weather forecast predicts a 90% chance of two inches of rain tomorrow. The forecasted data (two inches of rain) is likely to happen within a specified time period (tomorrow) with a 90% degree of confidence (a probability associated with the forecasted data). In some embodiments, forecasted consumer data 215 can be provided by the consumer (e.g., consumer 110A). In some embodiments, the forecasted consumer data 215 can be generated by the the SaaS management platform 120.

In some embodiments, the forecasted consumer data 215 includes forecasted organization data (e.g., forecasted values for the organization data 211). In some embodiments, forecasted organization data can include forecasted location data, forecasted employee data, forecasted financial data, or forecasted consumer sector data. For example, forecasted location data can include an anticipated opening (or closing) of a facility in, for instance, Hawaii or Utah or Texas. In another example, forecasted location data can include an anticipated shift towards- or away from remote work (e.g., working from home versus working onsite at a consumer facility). In another example, forecasted location data can include an anticipated global expansion (e.g., expansion of consumer organization into one or more countries). In another example, forecasted employee data can include an anticipated headcount growth from one-hundred employees to three-hundred or more employees over the next two years. In another example, forecasted employee data can include an anticipated headcount growth to five-hundred or more employees within the next year, which can trigger certain benefits package considerations (e.g., stop-loss or self-insurance considerations). In another example, forecasted financial data can include anticipated funding rounds or major influx of capital to- or outflow of capital from the consumer. In another example, forecasted consumer sector data can include information reflecting a major consumer sector disruption, for instance a financial collapse of a competitor or other consumers within the consumer sector.

In some embodiments, forecasted consumer data 215 includes forecasted demographic data. For example, forecasted demographic data can include information that identifies whether personnel of the consumer are trending older, towards marriage, or child-rearing ages. In another example, forecasted demographic data can include information reflecting a predicted need for fertility coverage, based on the overall age, gender representation, and health of employees of the consumer, as represented in the demographic data. In another example, forecasted demographic data can include information reflecting a predicted life event, such as a marriage or divorce, birth of a child, death of a family member, or other change in family members living in a household.

In some embodiments, forecasted consumer data 215 includes forecasted benefits usage data. For example, forecasted benefits usage data can include information that identifies whether personnel of the consumer are, for instance, likely to use benefits services related to having a child within the next year.

In some embodiments, forecasted consumer data 215 includes forecasted preference data. For example, forecasted preference data can include anticipated changes to a consumer's human resources (HR) management software provided by the consumer to personnel for managing respective benefit services provided by the producer.

Consumer cluster data 216 can reflect data generated by clustering the consumers 110A-110N, as described above with reference to FIG. 1. For example, consumer cluster data 216 can identify a particular cluster to which a consumer belongs (e.g., a cluster of consumers that share some characteristics). For instance, consumers of a cluster of consumers (e.g., a subset of the consumers 110A-110N) can be roughly the same size, have similar revenue, be located in similar geographic location(s) and so forth. The consumer cluster data 216 can include for example one or more of a cluster identifier that identifies a particular consumer cluster, a cluster membership reflecting the degree to which a consumer belongs to a particular cluster, a cluster centroid that identifies a representative “point” or average dataset for a particular consumer cluster, a value indicating a difference between a dataset of the consumer and the average dataset for a particular cluster, or the like. For example, consumer cluster data 216 can identify a consumer sector, such as, for example, the “tech” sector or “venture capital (VC)” sector. In some embodiments, the consumer cluster data 216 can identify one or more characteristics that are commonly shared (e.g., similar) across consumers (e.g., consumers 110A-110N) in the same consumer cluster. In some embodiments, consumer cluster data 216 can identify one or more characteristics of specific “adjacent consumers” (e.g., other consumers in the same consumer cluster).

As described above, producer data 220A can include one or more of information that describes types of products and/or services provided by the producer (e.g., benefits data 221), information that describes cost trends (e.g., trend data 222), information about the producer derived by the first-party organization (e.g., relationship data 223), or the like. An nth producer data 220N can be provided as an additional training input. For example, producer data 220A can be associated with a first producer, and nth producer data 220N can be associated with an nth producer. In some embodiments, producer data 220A-220N includes one or more of benefits data 221, trend data 222, relationship data 223, or the like.

Benefits data 221 can include information that describes the products and/or services provided by a producer. In some embodiments, benefits data 221 can include information that describes the characteristics of the products and/or services offered by the producer. In some embodiments, benefits data 221 can include one or more of (i) information about the functionality of the product or service, (ii) cost of the product or service, (iii) information about the availability of the product or service, (iv) requirements to receive or use the product or service, or (v) any other metric related to products or services offered by the producer. In some embodiments, a producer can provide multiple services and/or multiple products, each with different characteristics.

Trend data 222 can include information that describes trends with respect to a producer. For example, and in some embodiments, the trend data 222 can identify cost trends for producer products and/or services, including specific costs of products and services provided by the producer. In some embodiments, the trend data 222 can include one or more of (i) information that reflects the cost of products and services provided by a particular producer in comparison with the cost(s) of comparable service(s) provided by other producer(s) in the sector, or (ii) information that reflects whether the cost of products and/or services provided by the particular producer for a particular product and/or service are increasing (e.g., the service is getting more expensive) or decreasing (e.g., the service is getting less expensive). For example, if the cost of products and/or services provided by the producer are higher than the cost of similar or comparable products and services by other producers in the sector, the trend data 222 of the producer can reflect a lower value (e.g., a higher cost for services in comparison to other producers). In another example, if a producer continues to provide the same type or level of service while decreasing (or alternatively, increasing) the cost of the service, the trend data 222 can reflect that the cost of services is decreasing (or increasing, respectively). In some embodiments, the trend data 222 can be different for different products and/or services provided by the producer.

Relationship data 223 can include information that reflects a relationship between the producer and another party, such as the SaaS management platform 120. In some embodiments, relationship data 223 reflects one or more of (i) a relationship between SaaS management platform and a particular producer, or (ii) a perceived relationship that a producer has with consumer(s) that consume or use products and/or services of the consumer. In some embodiments, relationship data 223 includes sentiment data that reflects a level of good- or ill-will between the producer and the SaaS management platform, or between the producer and a consumer(s). In some embodiments, relationship data 223 includes information that reflects a quantity of interactions between the producer and the SaaS management platform. In some embodiments, relationship data 223 is generated and maintained by the SaaS management platform (e.g., the first-party organization) based, for example, on one or more of interactions between the SaaS management platform and a producer, or observations by the SaaS management platform of interactions between the producer and one or more consumers. In some embodiments, relationship data 223 is based at least in part on information provided by the producer and/or information provided by one or more consumers.

Forecasted producer data 224 can refer to information that estimates or predicts future outcomes, events, or trends related to a consumer. In some embodiments, forecasted producer data 224 can be similar to the forecasted consumer data 215, described above.

In some embodiments, the forecasted producer data 224 includes forecasted benefits data, forecasted trend data, or forecasted relationship data. For example, forecasted benefits data can include predicted benefits packages, or features of benefits packages that the producer is likely to continue to provide, or start/stop providing. In another example, forecasted trend data can include forecasted costs or cost trends for products and/or services provided by the producer. In another example, forecasted relationship data can reflect a preference by one or more of the agent (e.g., the SaaS management platform) or a particular producer to improve the relationship between the SaaS management platform and the particular producer.

As described above, external factor data 230 can include information that reflects one or more factors or variables, such as events, influences, or conditions that can impact one or more of a consumer or a producer. In some embodiments, the events, influences, or conditions can be external events, external influences, or external conditions. In some embodiments, the external factor data 230 can include one or more of producer sector data 231, economic data 232, world and/or natural event data 233, or the like.

Producer sector data 231 can include information related to a sector or industry(ies) of the producer. In some embodiments, the producer sector data 231 can describe the producer sector or industry. For example, producer sector data 231 of an insurance carrier can describe the insurance industry. In some embodiments, the producer sector data 231 can include one or more of statistics, performance data, trends, regulations, and/or characteristics of the producer industry.

Economic data 232 can include information regarding to micro- or macro-scale economic indicators that pertain to one or more of a consumer sector, a producer sector, a particular consumer, a particular producer, consumer-producer relationships, or a particular consumer-producer relationship. For example, an economic indicator can be an inflation rate of a currency, such as the United States dollar.

World and/or natural event data 233 (also referred to herein as “world event data”) can include information regarding social, cultural, political, or naturally-occurring events that pertain to one or more of a consumer sector, a producer sector, a particular consumer, a particular producer, consumer-producer relationships, or a particular consumer-producer relationship. For example, a political event can be a change in government policy, or political party dominance. In another example, a naturally-occurring event can be a disruptive avalanche, volcanic eruption, storm, earthquake, or the spread of an infectious disease.

Forecasted external factor data 234 can refer to information that estimates or predict future outcomes, events, or trends related to factors external to one or more of the consumer or producer. In some embodiments, forecasted external factor data 234 can be similar to the forecasted consumer data 215 or the forecasted producer data 224, described above.

In some embodiments, the forecasted external factor data 234 includes forecasted producer sector data, forecasted economic data, forecasted world and/or natural event data, or the like. For example, forecasted producer sector data can include information reflecting a major disruption in the producer sector, for instance a financial collapse of a competitor or other producer within the producer sector. In another example, forecasted economic data can include information reflecting a predicted inflation rate of a currency, such as the United States dollar. In another example, forecasted world and/or natural event data can include information reflecting a predicted regulatory framework or set of government policies that may apply to one or more consumers and/or one or more producers.

### Target Outputs

Target outputs 202 can include one or more of producer-consumer match data 241A through producer-consumer match data 241N (also referred to herein as “producer-consumer match data 241A-241N”).

In some embodiments, the producer-consumer match data can identify whether a particular producer is a match for a particular consumer. In some embodiments, the producer-consumer match data 241A can identify a particular producer based on the training inputs 201. For example, the producer-consumer match data 241A can identify a match between a producer associated with producer data 220A and a consumer associated with the consumer data 210A. In another example, the producer-consumer match data 241N can identify a producer associated with nth producer data 220N, and the consumer associated with the consumer data 210A. In some embodiments, the producer-consumer match data 241A-241N is generated for each consumer associated with a particular set of consumer data 210A-210N. For example, for a first consumer (e.g. with first consumer data), the training set generator can generate producer-consumer match data 241A-241N corresponding to producer data 220A-220N. For a second consumer (e.g., with second consumer data), the training set generator can generate producer-consumer match data 241A-241N corresponding to producer data 220A-220N.

In some embodiments, the producer-consumer match data 241A can identify a particular product and/or service of the producer. For example, the producer-consumer match data 241A can identify a first product and/or service provided by a producer associated with the producer data 220A. In another example, the producer-consumer match data 241A can identify a second product and/or service provided by the producer associated with the producer data 220A.

In some embodiments, subsequent to or based on generating a training set and training the model 160 using the training set, the model 160 can be further trained (e.g., additional data for a training set) or adjusted (e.g., adjusting weights associated with input data of the model 160, such as connection weights in a neural network). In some embodiments, the model 160 can be trained on additional training inputs (not illustrated) and additional target outputs (not illustrated).

FIG. 3 depicts a flow diagram of one example of a method 300 for training an AI model to identify a producer-consumer match, in accordance with aspects of the disclosure. The method is performed by processing logic that can include hardware (circuitry, dedicated logic, etc.), software (e.g., instructions run on a processing device), or a combination thereof. In one embodiment, some or all the operations of method 300 can be performed by one or more components of system 100 of of FIG. 1. In other embodiments, one or more operations of method 300 can be performed by training set generator 131 of server machine 130 as described with reference to FIG. 1 through FIG. 2. In some embodiments, one or more operations of method 300 can be performed by benefits module 151. It can be noted that components described with respect to FIG. 1 through FIG. 2 can be used to help illustrate aspects of FIG. 3. In some embodiments, the operations (e.g., operations 301-309) can be the same, different, fewer, or greater. For instance, in some embodiments one or more training inputs can be generated or one or more target outputs can be generated, and the one or more training inputs and one or more training outputs can be used as input-output pairs (for input) to train the AI model, such as model 160, to be used by the benefits module 151.

Method 300 generates training data for an AI model. In some embodiments, at operation 301, processing logic implementing the method 300 initializes the training set “T” to an empty set (e.g., “{ }”).

At operation 302, the processing logic generates a first training input including information identifying consumer data related to a consumer associated with a SaaS management platform. In some embodiments, the consumer data (e.g., consumer data 210A-210N) can include one or more of organization data 211, demographic data 212, benefits usage data 213, preference data 214, or the like. In some embodiments, the processing logic generates a training input comprising information identifying second consumer data related to a second consumer associated with the SaaS management platform.

At operation 303, the processing logic generates a second training input including information identifying producer data related to a producer that provides, via the SaaS management platform, one or more services to one or more consumers associated with the SaaS management platform. In some embodiments, the producer data (e.g., producer data 220A) can include one or more of benefits data 221, trend data 222, relationship data 223, or the like. In some embodiments, the processing logic further generates a training input comprising information identifying second producer data related a particular service of the one or more services provided by the producer, via the SaaS management platform, to the one or more consumers associated with the SaaS management platform. In some embodiments, the processing logic further generates a training input comprising information identifying second producer data related to a second producer. In some embodiments, the producer data 220A is in part based on historical producer data.

At operation 304, the processing logic generates a third training input comprising external factor data identifying one or more factors external to and that affect the consumer and the producer. In some embodiments, the external factor data (e.g., external factor data 230) includes one or more of producer sector data 231, economic data 232, world and/or natural event data 233, or the like. In some embodiments, the external factor data 230 is in part based on historical external factor data.

At operation 305, the processing logic generates a first target output for one or more of the first training input, the second training input and the third training input, wherein the first target output identifies whether the producer is a match for the consumer. In some embodiments, the target output identifies whether a service of the producer is a match for the consumer. In some embodiments, the first target output is producer match data (e.g., producer-consumer match data 241A). In some embodiments, the producer-consumer match data 241A is in part based on historical indications of producer matches to respective historical consumer data.

At operation 306, processing logic optionally generates mapping data that is indicative of an input/output mapping. The input/output mapping (or training set mapping data) can refer to the training input (e.g., one or more of the training inputs described herein), the set of target outputs for the training input (e.g., one or more of the target outputs described herein), and an association between the training input(s) and the target output(s).

At operation 307, processing logic adds the mapping data generated at operation 306 to the training set T.

At operation 308, processing logic branches base on whether training set T is sufficient for training the model 160. If so, execution proceeds to operation 309, otherwise, execution continues back at operation 302. It should be noted that in some embodiments, the sufficiency of training set T may be determined based simply on the number of input/output mappings in the training set, while in some other embodiments, the sufficiency of training set T may be determined based on one or more other criteria (e.g., a measure of diversity of the training examples, accuracy satisfying a threshold, etc.) in addition to, or instead of, the number of input/output mappings.

At operation 309, processing logic provides training set T to train the AI model (e.g., model 160). In one embodiment, training set T is provided to training engine 141 of server machine 140 to perform the training. In some embodiments, operation 309 can include training the AI model using the training set T. In the case of a neural network, for example, input values of a given input/output mapping (e.g., numerical values associated with training inputs 201) are input to the neural network, and output values (e.g., numerical values associated with target outputs 202) of the input/output mapping are stored in the output nodes of the neural network. The connection weights in the neural network are then adjusted in accordance with a learning algorithm (e.g., back propagation, etc.), and the procedure is repeated for the other input/output mappings in training set T. At operation 309, the AI model (e.g., model 160) can be trained using training engine 141 of server machine 140. The trained AI model (e.g., model 160) can be implemented by the benefits module 151 (of server machine 150, or SaaS management platform 120) to identify a producer match for a consumer.

FIG. 4 is an example method for using a trained AI model to identify a producer-consumer match, in accordance with aspects of the disclosure. In some embodiments, some, or all of the operations of the method 400 can be performed by one or more components of system 100 of FIG. 1, such as the benefits module 151. It can be noted that components described with reference to FIG. 1 can be used to illustrated aspects of FIG. 4. Although the method 400 is illustrated with a particular order, it can be appreciated that some of the operations can be performed serially or in parallel. In some embodiments, the operations can be the same, difference, fewer, or greater. The method 400 illustrates using a trained AI model to identify model output 404 based on a model input 403. A method for using the trained AI model to identify a producer match is described below with reference to FIG. 7.

In some embodiments, the benefits module 151 can obtain the input data 401 from one or more of a consumer 110A, producers 170A-170N, SMP services 129 of the SaaS management platform (not illustrated), or the data store 106 of the SaaS management platform. The benefits module 151 can provide the input data 401 to the model 160 to generate the output data 409. In some embodiments, the benefits module 151 can provide input data 401 that corresponds to a consumer 110A (e.g., input data including consumer data 210A) and receive output data 409 from the model 160 that corresponds to a first subset of the producers 170A-170N. In some embodiments, the benefits module 151 can provide input data 401 that corresponds to a consumer 110N (e.g., input data 401 including nth consumer data 210N) and receive output data 409 from the model 160 that corresponds to a second subset of the producers 170A-170N.

The input data 401 can include one or more of consumer data 210A, producer data 220A-220N, external factor data 230, or the like. In some embodiments, the benefits module 151 can obtain input data 401 about a first entity from a second entity. For example, and in some embodiments, the benefits module 151 can obtain a portion of the input data 401 about a consumer 110A from one or more of producer 170A-170N, another consumer (e.g., a consumer 110N, not illustrated), the SMP services 129 or an external third-party. In another example, and in some embodiments, the benefits module 151 can obtain a portion of the input data 401 about a producer 170A-170N from one or more of a consumer 110A-110N, another producer 170A-170N, the SMP services 129 or an external third-party. For example, and in some embodiments, the benefits module 151 can use an API to access a portion of the input data 401 from one or more of the consumer 110A, the producers 170A-170N, or the SMP services 129.

In some embodiments, one or more of the consumer 110A, the producers 170A-170N, or SMP services 129 (or a component of SMP services 129) can provide portions of one or more of consumer data 210A, producer data 220A-220N, or external factor data 230 to the benefits module 151. In some embodiments, the SaaS management platform can generate some or all of one or more of the consumer data 210A, the producer data 220A-220N, or the external factor data 230. In some embodiments, a portion of the input data 401 can be stored in the data store 106.

In some embodiments, the consumer data 210A includes one or more of organization data (e.g., organization data 211), demographic data (e.g., demographic data 212), benefits usage data (e.g., benefits usage data 213), preference data (e.g., preference data 214), forecasted consumer data (e.g., forecasted consumer data 215), consumer cluster data (e.g., consumer cluster data 216), or the like. As described above, organization data 211 can include information that describes the consumer, such as one or more of location data, employee data, financial data, or consumer sector data. As described above, demographic data 212 can include information that describes characteristics of personnel (e.g., employees) associated with the consumer. As described above, benefits usage data 213 can include information that describes a consumer's usage of services provided by a producer. As described above, preference data 214 can include information that reflects consumer preference(s).

In some embodiments, the producer data 220A-220N includes one or more of benefits data (e.g., benefits data 221), trend data (e.g., trend data 222), relationship data (e.g., relationship data 223), or the like. As described above, benefits data 221 can include information that describes the products and/or services provided by the producer. As described above, trend data 222 can include information that describes trends with respect to the producer. As described above, relationship data 223 can include information that reflects a relationship between the producer and another party, such as the SaaS management platform.

In some embodiments, the external factor data 230 includes one or more of producer sector data (e.g., producer sector data 231), economic data (e.g., economic data 232), world and/or natural event data (e.g., world and/or natural event data 233), or the like. As described above, producer sector data 231 can include information related to a sector or industry(ies) of the producer. As described above, economic data 232 can include information pertaining to micro- or macro-scale economic indicators that pertain to one or more of a consumer sector, a producer sector, a particular consumer, a particular producer, consumer-producer relationships, or a particular consumer-producer relationship. As described above, world and/or natural event data 233 can include information pertaining to social, cultural, political, or naturally occurring events that pertain to one or more of a consumer sector, a producer sector, a particular consumer, a particular producer, consumer-producer relationships, or a particular consumer-producer relationship.

The benefits module 151 can provide the input data 401 to an input module 402 of the benefits module 151. In some embodiments, the input module 402 processes the input data 401 into a model input 403 that can be received and processed by the model 160. In some embodiments, the input data 401 can be used directly as model input 403. That is, the model input 403 can include one or more of the consumer data 210A, the producer data 220A-220N, or the external factor data 230. In alternative embodiments, the input module 402 can transform data in the input data 401 into processed data to be used in the model input 403 as input to the model 160. For example, and in some embodiments, the input module 402 can transform the consumer data 210A of the input data 401 into processed consumer data 410 (e.g., embeddings). In another example, and in some embodiments, the input module 402 can transform the producer data 220A-220N of the input data 401 into the processed producer data 420A-420N. In another example, and in some embodiments, the input module 402 can transform the external factor data 230 into processed external factor data 430.

In some embodiments, processing of the input data 401 performed at the input module 402 can remove one or more portions of the input data 401. For example, the input module 402 can remove financial data from the consumer data 210A to generate the processed consumer data 410. In some embodiments, processing performed at the input module 402 can include anonymization of consumer or employee information. In some embodiments, processing of the input data 401 performed at the input module 402 can include one or more changes to the input data 401 based on one or more criteria. In some embodiments, the processing of the input data 401 at the input module 402 can be performed based on one or more characteristics of the SaaS management platform. In some embodiments, the processing of the input data 401 at the input module 402 can be performed based on one or more characteristics of the consumer 110A. In some embodiments, the processing of the input data 401 at the input module 402 can be performed based on one or more characteristics of a producer.

The benefits module 151 can provide the model input 403 to the model 160. The model 160 can be trained to generate the model output 404 based on the model input 403, as described above with reference to FIG. 1 and FIG. 2. For example, the model 160 can be trained with training data described in FIG. 2.

The benefits module 151 can obtain a model output 404 from the model 160. In some embodiments, the model output 404 can include producer data 441A-441N. In some embodiments, the producer data 441A-441N can identify one or more producer(s) and corresponding levels of confidence that a particular producer matches a consumer (e.g., the consumer associated with the consumer data 210A of the input data 401). In some embodiments, the producer data 441A-441N can identify one or more products and/or services of a particular producer (e.g., represented by one of a producer data 220A-220N) that match a consumer (e.g., represented by the consumer data 210A).

In some embodiments, the benefits module 151 can provide the model output 404 (e.g., a notification identifying the output) to the SMP services 129 of the SaaS management platform. In some embodiments, the benefits module 151 can provide the model output 404 as output data 409. For example, the output data 409 (e.g., a notification identifying the output) can be provided to one or more of a consumer 110A-110N or a producer 170A-170N. In alternative embodiments, the benefits module 151 can provide the model output 404 to an output module 405 of the benefits module 151.

The output module 405 of the benefits module 151 can perform one or more post-processing operations on the model output 404. In some embodiments, the output module 405 can generate the output data 409. In some embodiments, the output module 405 can generate an indication of producer data 451A-451N. For example, and in some embodiments, the output module 405 can extract raw data from the model output 404 and generate a human-readable indication of the model output 404. In some embodiments, the output data 409 is provided to one or more of the consumer 110A, the producers 170A-170N, or the SMP services 129.

In some embodiments, the output data 409 is provided to the consumer 110A as a notification that includes one or more producers identified in the producer data 441A-441N and/or corresponding confidence levels that the identified producers are a match for the consumer 110A. For example, the notification can include the output data 409 as a list of producers and corresponding levels of confidence that the identified producers are a match for the consumer 110A.

In some embodiments, the output data 409 is provided to one or more of the producers 170A-170N that are identified in the producer data 441A-441N as a notification. The notification to the producers 170A-170N identified in the producer data 441A-441N can include a request for a proposal to provide products and/or services to the consumer 110A. In some embodiments, the notification can include portions of one or more of consumer data 210A, producer data 220A, or external factor data 230. For example, the notification can include consumer data 210A and relationship data (of the producer data 220A corresponding to the particular producer).

In some embodiments, the output data 409 is provided to the SMP service 129. The SMP services 129 can subsequently provide the output data 409 to one or more of the consumer 110A, or one or more producers 170A-170N. In some embodiments, the indication of producer data 451A-451N can be a notification that identifies a particular producer, a list of producers 170A-170N, one or more levels of confidence that the particular producer or list of producers match the consumer, one or more values representing one or more corresponding characteristics (e.g., of a particular consumer and/or one or more producers), or the like. In some embodiments, the output module 405 can generate the output data 409 for the consumer 110A (or, alternatively, the SaaS management platform) based at least in part on information stored in the data store 106.

In some embodiments, the output module 405 can determine whether a level of confidence that a particular producer is a match for a consumer satisfies a threshold level of confidence. In some embodiments, the threshold level of confidence can be configured based on information received from one or more of a consumer 110A-110N, a producer 170A-170N, or generated by the SaaS management platform 120. In some embodiments, responsive to determining the level of confidence satisfies the threshold level of confidence, the output module 405 can generate output data 409 for one or more of the producer, the consumer, or the SaaS management platform 120. For example, and in some embodiments, the output module 405 can generate a notification (e.g., output data 409 containing the indication of producer data 451A-451N) for a producer to request information pertaining to products and/or services that may be provided by the producer to the consumer. In some embodiments, the output module 405 can generate output data 409 for each producer 170A-170N identified in the producer data 441A-441N. In some embodiments, the output module 405 can sort the producers 170A-170N that are identified in the producer data 441A-441N based on the respective confidence levels that a particular producer identifier corresponds to the consumer.

In some embodiments, the output data 409 can be presented in various mediums, such as in a file, as a pop-up, a message (e.g., an email message, a text message, or a message within an application), or as an alert. In another example, a user of one or more of the the SaaS management platform, the consumer 110A, or the producer 170A-170N can be presented with an email message including a textual description of the output data 409 (e.g., the indication of producer data 451A-451N).

FIG. 5 depicts a flow diagram of one example of a method 500 for identifying a consumer-producer match, in accordance with aspects of the disclosure. The method 500 is performed by processing logic that can include hardware (circuitry, dedicated logic, etc.), software (e.g., instructions run on a processing device), or a combination thereof. In one embodiment, some or all the operations of method 500 can be performed by one or more components of system 100 of FIG. 1, such as the benefits module 151. It can be noted that components described with reference to FIG. 1 can be used to illustrate aspects of FIG. 5. In some embodiments, the operations (e.g., operations 501-504) can be the same, different, fewer, or greater. In some embodiments, method 500 can use a trained AI model to identify producer match data based on one or more of consumer data, producer data, external factor data, or the like.

At operation 501, the processing logic performing the method 500 provides a trained AI model a first input comprising information identifying consumer data related to a consumer associated with a software-as-a-service (SaaS) management platform. In some embodiments, the consumer data (e.g., consumer data 210A of FIG. 2) includes organization data reflecting information that describes the consumer (e.g., organization data 211 of FIG. 2). In some embodiments, the consumer data includes demographic data reflecting characteristics of employees associated with the consumer (e.g., demographic data 212 of FIG. 2). In some embodiments, the consumer data includes benefits usage data reflecting a usage by the consumer of a service provided by the consumer (e.g., benefits usage data 213 of FIG. 2). In some embodiments, the consumer data includes preference data reflecting one or more preferences of the consumer pertaining to a service provided by the producer (e.g., preference data 214 of FIG. 2).

At operation 502, the processing logic provides to the trained AI model a second input comprising information identifying producer data related to a producer that provides, via the SaaS management platform, a service to one or more consumers associated with the SaaS management platform. In some embodiments, the producer data (e.g., producer data 220A of FIG. 2) includes benefits data reflecting information pertaining to a service provided by the producer (e.g., benefits data 221 of FIG. 2). In some embodiments, the producer data includes trend data reflecting information pertaining to cost trends for a service provided by the producer (e.g., trend data 222 of FIG. 2). In some embodiments, the producer data includes relationship data reflecting information pertaining to a relationship between the producer and the SaaS management platform (e.g., relationship data 223 of FIG. 2).

At operation 503, the processing logic provides to the trained AI model a third input comprising external factor data identifying one or more factors external to and that affect the consumer and the producer. In some embodiments, the external factor data (e.g., external factor data 230) includes producer sector data reflecting information related to a sector or industry(ies) of the producer (e.g., producer sector data 231 of FIG. 2). In some embodiments, the external factor data can include economic data reflecting information regarding micro- or macro-scale economic indicators that pertain to one or more of a consumer sector, a producer sector, a particular consumer, a particular producer, consumer-producer relationships, or a particular consumer-producer relationship (e.g., economic data 232 of FIG. 2). In some embodiments, the external factor data can include world event data reflecting information regarding social, cultural, political, or naturally-occurring events that pertain to one or more of a consumer sector, a producer sector, a particular consumer, a particular producer, consumer-producer relationships, or a particular consumer-producer relationship (e.g., world and/or natural event data 233 of FIG. 2).

At operation 504, the processing logic obtains, from the trained AI model, one or more outputs identifying (i) the producer, and (ii) a level of confidence that the producer is a match for the consumer. In some embodiments, the one or more outputs further identify (iii) a service provided by the producer and (iv) a level of confidence that the service of the producer is a match for the consumer. In some embodiments, multiple producers and corresponding levels of confidence can be included in the one or more outputs from the trained AI model. In some embodiments, multiple services from a particular producer and corresponding levels of confidence can be included in the one or more outputs from the trained AI model. In some embodiments, multiple services from multiple producers and corresponding levels of confidence can be included in the one or more outputs from the trained AI model.

At operation 505, the processing logic determines whether the level of confidence that the first producer is the match for the consumer satisfies a threshold level of confidence.

At operation 506, the processing logic provides a notification identifying the first producer and indicating that the first producer is the match for the consumer. In some embodiments, the notification identifying the first producer can be provided in response to the processing logic determining that the level of confidence that the first producer is the match for the consumer satisfies the threshold level of confidence, as in operation 505.

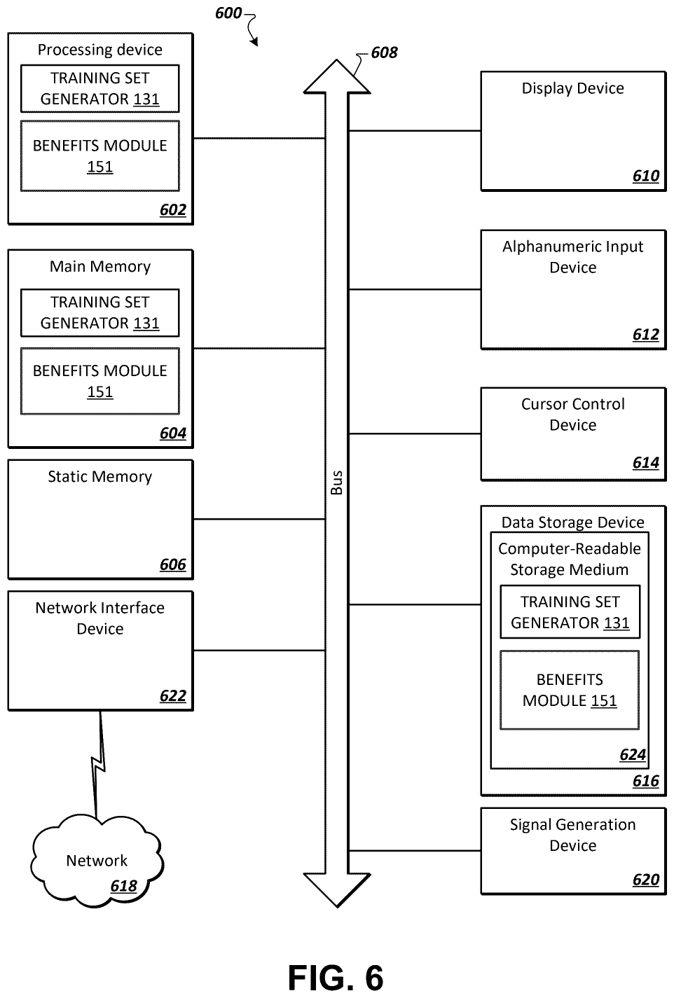

FIG. 6 is a block diagram illustrating an exemplary computer system, system 600, in accordance with aspects of the disclosure. The system 600 executes one or more sets of instructions that cause the machine to perform any one or more of the methodologies discussed herein. Set of instructions, instructions, and the like can refer to instructions that, when executed system 600, cause the system 600 to perform one or more operations of training set generator 131 or the benefits module 151. The machine can operate in the capacity of a server or a client device in client-server network environment, or as a peer machine in a peer-to-peer (or distributed) network environment. The machine can be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 616, which communicate with each other via a bus 608.

The processing device 602 represents one or more general-purpose processing devices such as a microprocessor, central processing unit, or the like. More particularly, the processing device 602 can be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 602 can also be one or more special-purpose processing devices such as an application specific integrated circuit (ASIC), a field programmable gate array (FPGA), a digital signal processor (DSP), network processor, or the like. The processing device 602 is configured to execute instructions of the system 100 and the training set generator 131 or the benefits module 151 for performing the operations discussed herein.

The system 600 can further include a network interface device 622 that provides communication with other machines over a network 618, such as a local area network (LAN), an intranet, an extranet, or the Internet. The system 600 also can include a display device 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 can include a computer-readable storage medium 624 on which is stored the sets of instructions of the system 100 and of training set generator 131 or of the benefits module 151 embodying any one or more of the methodologies or functions described herein. The computer-readable storage medium 624 can be a non-transitory computer-readable storage medium. The sets of instructions of the system 100 and of training set generator 131 or of the benefits module 151 can also reside, completely or at least partially, within the main memory 604 and/or within the processing device 602 during execution thereof by the system 600, the main memory 604 and the processing device 602 also constituting computer-readable storage media. The sets of instructions can further be transmitted or received over the network 618 via the network interface device 622.

While the example of the computer-readable storage medium 624 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding, or carrying a set of instructions for execution by the machine and that cause the machine to perform any one or more of the methodologies of the disclosure. The term “computer-readable storage medium” can include, but not be limited to, solid-state memories, optical media, and magnetic media. For example, the term “computer-readable storage medium” can include a non-transitory computer readable storage medium.

In the foregoing description, numerous details are set forth. It will be apparent, however, to one of ordinary skill in the art having the benefit of this disclosure, that the disclosure can be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It can be borne in mind, however, that all of these and similar terms are to be associated with the appropriate physical quantities and are merely convenient labels applied to these quantities. Unless specifically stated otherwise, it is appreciated that throughout the description, discussions utilizing terms such as “generating,” “providing,” “obtaining,” “identifying,” “determining,” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus can be specially constructed for the required purposes, or it can include a general purpose computer selectively activated or reconfigured by a computer program stored in the computer. Such a computer program can be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims can generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and cannot necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure can, therefore, be determined with reference to the appended claims, along with the full scope of equivalents to which such claims are entitled.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. A method comprising:
providing, to a trained AI model a first input, the first input comprising information identifying client data related to a client organization associated with a software-as-a-service (SaaS) management platform, wherein the client organization is associated with one or more client devices and an account of the SaaS management platform, and wherein each client device is associated with at least one of a plurality of employees of the client organization, wherein the client data comprises demographic data that identifies i) an age of each of the plurality of employees, and ii) a family status of each of the plurality of employees;
providing to the trained AI model a second input, the second input comprising information identifying service provider data related to a first third-party service provider, wherein the first third-party service provider uses the SaaS management platform to facilitate providing one or more services to one or more employees of the client organization;
providing to the trained AI model a third input, the third input comprising external factor data identifying one or more factors external to and that affect the client organization and the first third-party service provider; and
generating by the trained AI model, one or more outputs identifying (i) the first third-party service provider, and (ii) a level of confidence that the first third-party service provider is a match for the client organization.

12. The method of claim 11, further comprising:
providing a notification identifying the first third-party service provider and indicating that the first third-party service provider is the match for the client organization.

13. The method of claim 12, further comprising:
determining whether the level of confidence that the first third-party service provider is the match for the client organization satisfies a threshold level of confidence,
wherein providing the notification identifying the first third-party service provider and indicates that the first third-party service provider is the match for the client organization is responsive to determining that the level of confidence satisfies the threshold level of confidence.

14. The method of claim 11, further comprising:
providing to the trained AI model a fourth input, the fourth input comprising information identifying service provider data related to a second third-party service provider that provides, via the SaaS management platform, the service to one or more client organization associated with the SaaS management platform; and
wherein the one or more outputs identifying (iii) the second third-party service provider, and (iv) a level of confidence that the second third-party service provider is a match for the client organization.

15. The method of claim 11, wherein the one or more outputs further identify (v) the service of the third-party service provider, and (vi) a level of confidence that the service of the first third-party service provider is a match for the client organization.

16. The method of claim 11, wherein the client data comprises organization data reflecting information that describes the client organization.

17. (canceled)

18. The method of claim 11, wherein the client data comprises benefits usage data reflecting a historical usage of the service by the client organization and provided by a third third-party service provider.

19. The method of claim 11, wherein the client data comprises preference data reflecting one or more preferences of the client organization pertaining to the service provided by the first third-party service provider.

20. The method of claim 11, wherein the service provider data comprises benefits data reflecting information pertaining to the service provided by the first third-party service provider.

21. The method of claim 11, wherein the service provider data comprises trend data reflecting information pertaining to cost trends for the service provided by the first third-party service provider.

22. The method of claim 11, wherein the service provider data comprises relationship data reflecting information pertaining to a relationship between the first third-party service provider and the SaaS management platform.

23. The method of claim 11, wherein the external factor data comprises one or more of sector data related to a sector of the first third-party service provider, economic data related to one or more economic indicators, or world event data related to one or more events external to the first third-party service provider and the client organization.

24. (canceled)

25. A system comprising: a memory; and
one or more processing devices coupled to the memory, the one or more processing devices configured to perform operations comprising:
providing, to a trained AI model a first input, the first input comprising information identifying client data related to a client organization associated with a software-as-a-service (SaaS) management platform, wherein the client organization is associated with one or more client devices and an account of the SaaS management platform, and wherein each client device is associated with at least one of a plurality of employees of the client organization, wherein the client data comprises demographic data that identifies i) an age of each of the plurality of employees, and ii) a family status of each of the plurality of employees;
providing to the trained AI model a second input, the second input comprising information identifying service provider data related to a first third-party service provider, wherein the first third-party service provider uses the SaaS management platform to facilitate providing one or more services to one or more employees of the client organization;
providing to the trained AI model a third input, the third input comprising external factor data identifying one or more factors external to and that affect the client organization and the first third-party service provider; and
generating by the trained AI model, one or more outputs identifying (i) the first third-party service provider, and (ii) a level of confidence that the first third-party service provider is a match for the client organization.

26. The system of claim 25, the operations further comprising:
providing a notification identifying the first third-party service provider and indicating that the first third-party service provider is the match for the client organization.

27. The system of claim 26, the operations further comprising:
determining whether the level of confidence that the first third-party service provider is the match for the client organization satisfies a threshold level of confidence,
wherein providing the notification identifying the first third-party service provider and indicates that the first third-party service provider is the match for the client organization is responsive to determining that the level of confidence satisfies the threshold level of confidence.

28. The system of claim 25, the operations further comprising:
providing to the trained AI model a fourth input, the fourth input comprising information identifying service provider data related to a second third-party service provider that provides, via the SaaS management platform, the service to one or more client organization associated with the SaaS management platform; and
wherein the one or more outputs identifying (iii) the second third-party service provider, and (iv) a level of confidence that the second third-party service provider is a match for the client organization.

29. The system of claim 25, wherein the one or more outputs further identify (v) the service of the third-party service provider, and (vi) a level of confidence that the service of the first third-party service provider is a match for the client organization.

30. The system of claim 25, wherein the client data comprises organization data reflecting information that describes the client organization.

31. (canceled)

32. The system of claim 25, wherein the client data comprises benefits usage data reflecting a historical usage of the service by the client organization and provided by a third third-party service provider.

33. The system of claim 25, wherein the client data comprises preference data reflecting one or more preferences of the client organization pertaining to the service provided by the first third-party service provider.

34. The system of claim 25, wherein the service provider data comprises benefits data reflecting information pertaining to the service provided by the first third-party service provider.

35. The system of claim 25, wherein the service provider data comprises trend data reflecting information pertaining to cost trends for the service provided by the first third-party service provider.

36. The system of claim 25, wherein the service provider data comprises relationship data reflecting information pertaining to a relationship between the first third-party service provider and the SaaS management platform.
